(19) United States
(12) Patent Application Publication
(10) Pub. No.: US 2024/0323708 A1
(43) Pub. Date: Sep. 26, 2024

(54) NETWORK SLICE QUOTAS IN THE PRESENCE OF INTERWORKING

(71) Applicant: Telefonaktiebolaget LM Ericsson (publ), Stockholm (SE)

(72) Inventors: George Foti, Dollard des Ormeaux (CA); Peter Hedman, Helsingborg (SE); Ralf Keller, Würselen (DE)

(21) Appl. No.: 18/028,228

(22) PCT Filed: Sep. 17, 2021
(86) PCT No.: PCT/IB2021/058501

§ 371 Date: Mar. 24, 2023

Related U.S. Application Data
(60) Provisional application No. 63/083,578, filed on Sep. 25, 2020.

(51) Int. Cl. H04W 24/02; H04W 60/00; H04W 76/12

(52) U.S. Cl. CPC H04W 24/02; H04W 60/00; H04W 76/12

(57) ABSTRACT

Embodiments of a method for handling a quota(s) for a network slice that supports interworking between first and second cellular communications systems are disclosed. In one embodiment, the method comprises, at a first Network Function (NF), receiving a message associated to: registration or attachment of a User Equipment (UE) with the first cellular communications system for a particular network slice that supports interworking, registration or attachment of the UE with the second cellular communications system for the particular network slice, establishment of a session in the first cellular communications system for the particular network slice, or establishment of a session in the second cellular communications system for the particular network slice. The method further comprises, at the first NF, determining that a quota check is needed and performing a procedure to check the quota for the particular network slice and, if needed, update an associated count.

### RELATED APPLICATIONS

This application claims the benefit of provisional patent application Ser. No. 63/083,578, filed Sep. 25, 2020, the disclosure of which is hereby incorporated herein by reference in its entirety.

### TECHNICAL FIELD

The present disclosure relates to network slicing in a cellular

communications system and, more specifically, to maintaining User Equipment (UE) and/or session quotas for network slices in the presence of interworking.

BACKGROUND

Solution #6 described in Section 6.6 of Third Generation Partnership Project (3GPP) Technical Report (TR) 23.700-40 V0.5.0 “Study on enhanced network slicing” provides a solution for Policy Control Function (PCF) based counting of Protocol Data Unit (PDU) sessions in a network slice. Section 6.6.1 of 3GPP TR 23.700-40 V0.5.0 states:
This solution addresses KI #2 and may be applicable to KI #1 also with the constraint the UE has a PDU session established at least. It allows an operator to count how many PDU Sessions are in a Network Slice identified by a S-NSSAI in the HPLMN. Then, several actions could be implemented based on this information that is always up to date. For the purposes of this solution, we assume a single global quota exists, i.e. irrespective of roaming. In this Solution description PCF may also refer to PCF set when this is the deployed approach in a PLMN. Also, this solution can be used to count the number of UEs in a Network Slice that have at least one PDU Session established. Finally, in scenarios where restricting the number of PDU Sessions/UEs per S-NSSAI by also counting the UEs that have moved to or are in the EPS, this solution allows that by letting the PGW-C/SMF interact with PCF for this purpose.

There currently exist certain challenge(s). Quotas for network slices (i.e., quotas for Subscribed Network Slice Assistance Informations (S-NSSAIs) associated to those network slices) apply only to User Equipments (UEs) and PDU sessions in the Fifth Generation System (5GS) (see, e.g., Section 6.6 of 3GPP TR 23.700-40 V0.5.0). However, when Evolved Packet System (EPS) interworking (IWK) is supported for S-NSSAIs subject to quotas, it is not currently specified what the behavior should be. This applies to quotas related to number of User Equipments (UEs) registered in an S-NSSAI, and the number of Protocol Data Unit (PDU) sessions allowed for an S-NSSAI.

### SUMMARY

Systems and methods are disclosed herein for handling network slice quotas in a manner that supports interworking between cellular communications systems. In one embodiment, a method for handling one or more quotas for a network slice that supports interworking between a first cellular communications system and a second cellular communications system comprises, at a first Network Function (NF), receiving a message associated to: registration or attachment of a User Equipment (UE) with the first cellular communications system for a particular network slice that supports interworking between the first cellular communications system and the second cellular communications system, registration or attachment of the UE with the second cellular communications system for the particular network slice, establishment of a session in the first cellular communications system for the particular network slice, or establishment of a session in the second cellular communications system for the particular network slice. The method further comprises, at the first NF, determining that a quota check for a quota is needed for the UE for the particular network slice and performing a procedure to check the quota for the particular network slice and, if needed, update an associated count, upon determining that a quota check is needed. In this manner, an efficient mechanism for maintaining and using quotas for network slices that support interworking is provided.

In one embodiment, the quota is a quota for a number of registered UEs for the particular network slice. In one embodiment, the first cellular communications system is a Fifth Generation System (5GS), the second cellular communications system is an Evolved Packet System (EPS), and the first NF is a Unified Data Management (UDM) or a combined UDM/Home Subscriber Server (HSS). In one embodiment, determining that a quota check for the quota is needed for the UE for the particular network slice comprises determining that the network slice supports interworking and is subject to the quota. In one embodiment, determining that a quota check for the quota is needed for the UE for the particular network slice comprises determining that the UE has not already been counted in a number of UEs registered for the particular network slice. In one embodiment, prior to receiving the message, the UE was handed over from the first cellular communications system to the second cellular communications system or vice versa, and determining that a quota check for the quota is needed for the UE for the particular network slice comprises determining that the UE has not already been counted in a number of UEs registered for the particular network slice prior to being handed over. In another embodiment, the associated count is not increased if the UE has already been counted in a number of UEs registered for the particular network slice.

In one embodiment, the quota is a quota for a number of sessions for the particular network slice. In one embodiment, the first cellular communications system is a 5GS, the second cellular communications system is an EPS, and the first NF is a Session Management Function (SMF) or a combined SMF and Packet Data Network (PDN) Gateway Control plane (PGW-C). In one embodiment, determining that a quota check for the quota is needed for the UE for the particular network slice comprises determining that the network slice supports interworking and is subject to the quota. In one embodiment, determining that a quota check for the quota is needed for the UE for the particular network slice comprises determining that a session of the UE over the particular network slice has not already been counted in a number of sessions for the particular network slice. In one embodiment, prior to receiving the message, the UE was handed over from the first cellular communications system to the second cellular communications system or vice versa, and determining that a quota check for the quota is needed for the UE for the particular network slice comprises determining that a session of the UE over the particular network slice has not already been counted in a number of sessions for the particular network slice prior to being handed over. In another embodiment, the associated count is not increased if the session of the UE has already been counted in a number of UEs registered for the particular network slice.

In one embodiment, performing the procedure to check the quota for the particular network slice and, if needed, update an associated count comprises sending a message to a central NF to request a quota check for the quota for the particular network slice, receiving a response from the central NF, and determining whether the quota has been reached based on the response from the central NF. In one embodiment, performing the procedure to check the quota for the particular network slice and, if needed, update an associated count further comprises sending a notification to the central NF to adjust a count maintained for the quota upon determining that the quota has not been reached, and otherwise refraining from sending a notification to the central NF to adjust the count maintained for the quota. In one embodiment, the method further comprises, at the central NF, receiving a message from the first NF to request the quota check for the quota for the particular network slice and sending the response to the first NF. In one embodiment, the method further comprises, at the central NF, adjusting the count in response to receiving the notification from the first NF.

In one embodiment, performing the procedure to check the quota for the particular network slice and, if needed, update an associated count comprises adjusting the count locally upon determining that the quota has not been reached.

In one embodiment, performing the procedure to check the quota for the particular network slice and, if needed, update an associated count comprises checking the quota locally at the first NF.

Corresponding embodiments of a network node for implementing a first NF for handling one or more quotas for a network slice that supports interworking between a first cellular communications system and a second cellular communications system are disclosed. In one embodiment, a network node is adapted to receive a message associated to registration or attachment of a UE with the first cellular communications system for a particular network slice that supports interworking between the first cellular communications system and the second cellular communications system, registration or attachment of the UE with the second cellular communications system for the particular network slice, establishment of a session in the first cellular communications system for the particular network slice, or establishment of a session in the second cellular communications system for the particular network slice. The network node is further adapted to determine that a quota check for a quota is needed for the UE for the particular network slice and perform a procedure to check the quota for the particular network slice and, if needed, update an associated count, upon determining that a quota check is needed.

In another embodiment, a network node for implementing a first NF for handling one or more quotas for a network slice that supports interworking between a first cellular communications system and a second cellular communications system comprises processing circuitry configured to cause the network node to receive a message associated to registration or attachment of a UE with the first cellular communications system for a particular network slice that supports interworking between the first cellular communications system and the second cellular communications system, registration or attachment of the UE with the second cellular communications system for the particular network slice, establishment of a session in the first cellular communications system for the particular network slice, or establishment of a session in the second cellular communications system for the particular network slice. The processing circuitry is further configured to cause the network node to determine that a quota check for a quota is needed for the UE for the particular network slice and perform a procedure to check the quota for the particular network slice and, if needed, update an associated count, upon determining that a quota check is needed.

Embodiments of a method performed by a central NF for handling one or more quotas for a network slice that supports interworking between a first cellular communications system and a second cellular communications system are also disclosed. In one embodiment, the method performed by the central NF comprises receiving a message from a first NF to request a quota check for a quota for a particular network slice and sending a response to the first NF.

In one embodiment, the method further comprises receiving a notification from the first NF to adjust a count maintained for the quota and adjusting the count in response to receiving the notification from the first NF.

In one embodiment, the central NF increases the count if a respective UE or a respective session of the UE has not already been counted for the particular network slice.

Corresponding embodiments of a network node for implementing a central NF for handling one or more quotas for a network slice that supports interworking between a first cellular communications system and a second cellular communications system are also disclosed. In one embodiment, the network node is adapted to receive a message from a first NF to request a quota check for a quota for a particular network slice and send a response to the first NF.

In one embodiment, the network node is further adapted to receive a notification from the first NF to adjust a count maintained for the quota and adjust the count in response to receiving the notification from the first NF.

In one embodiment, the network node is further adapted to increase the count if a respective UE or a respective session of the UE has not already been counted for the particular network slice.

In another embodiment, a network node for implementing a central NF for handling one or more quotas for a network slice that supports interworking between a first cellular communications system and a second cellular communications system comprises processing circuitry configured to cause the network node to receive a message from a first NF to request a quota check for a quota for a particular network slice and send a response to the first NF.

In one embodiment, the processing circuitry is further configured to cause the network node to receive a notification from the first NF to adjust a count maintained for the quota and adjust the count in response to receiving the notification from the first NF.

In one embodiment, the processing circuitry is further configured to cause the network node to increase the count if a respective UE or a respective session of the UE has not already been counted for the particular network slice.

In another embodiment, a method for handling one or more quotas for a network slice that supports interworking between a first cellular communications system and a second cellular communications system comprises, at a first NF, maintaining a count of registered UEs associated to a network slice that supports interworking between a first cellular communications system and a second cellular communications system such that a UE is counted as a registered UE for the network slice if the UE has at least one session associated to the network slice in either the first cellular communications system or the second cellular communications system.

In one embodiment, the first cellular communications system is a 5GS and the second cellular communications system is an EPS. In one embodiment, the first NF is a UDM or a combined UDM/HSS. In one embodiment, a UE is counted as a registered UE for the network slice if the UE has any of: (a) at least one Protocol Data Unit, PDU, session associated to the network slice in the 5GS or (b) at least one Packet Data Network, PDN, connection associated to the network slice in the EPS.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a cellular communications system in which embodiments of the present disclosure may be implemented;

FIG. 2 illustrates one example of the cellular communications system of FIG. 1;

FIG. 3 illustrates the operation of the cellular communications system of

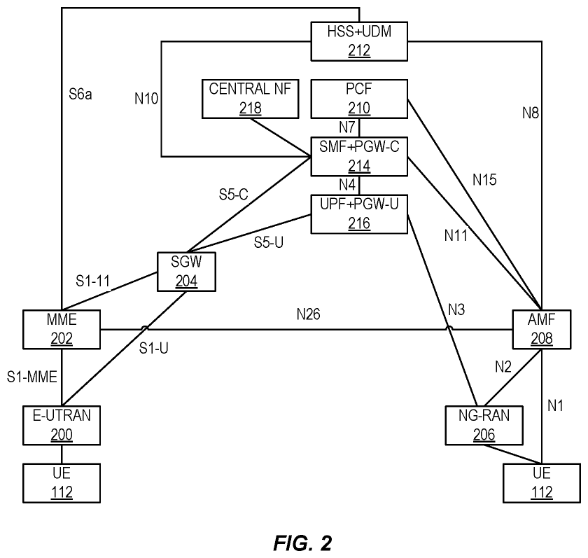

FIG. 2 in accordance with an example embodiment of the present disclosure;

FIG. 4 illustrates a Fifth Generation (5G) User Equipment (UE) registration procedure in which a Unified Data Management (UDM)/Home Subscriber Server (HSS) handles quotas for the number of UEs registered for a network slice in accordance with one embodiment of the present disclosure;

FIG. 5 illustrates a Protocol Data Unit (PDU) Session Establishment procedure in which a combined Session Management Function (SMF) and Packet Data Network (PDN) Gateway Control plane (PGW-C) (SMF+PGW-C) handles quotas for the number of PDU sessions or PDN connections for a network slice in accordance with one embodiment of the present disclosure;

FIGS. 6A and 6B illustrate an Evolved Packet System (EPS) initial attach procedure in which the UDM/HSS handles quotas for the number of registered UEs for a network slice and/or the SMF+PGW-C handles quotas for the number of PDU sessions or PDN connections for a network slice in accordance with one embodiment of the present disclosure;

FIG. 7 illustrates a UE requested PDN connectivity procedure in which the SMF+PGW-C handles quotas for the number of PDU sessions or PDN connections for a network slice in accordance with one embodiment of the present disclosure;

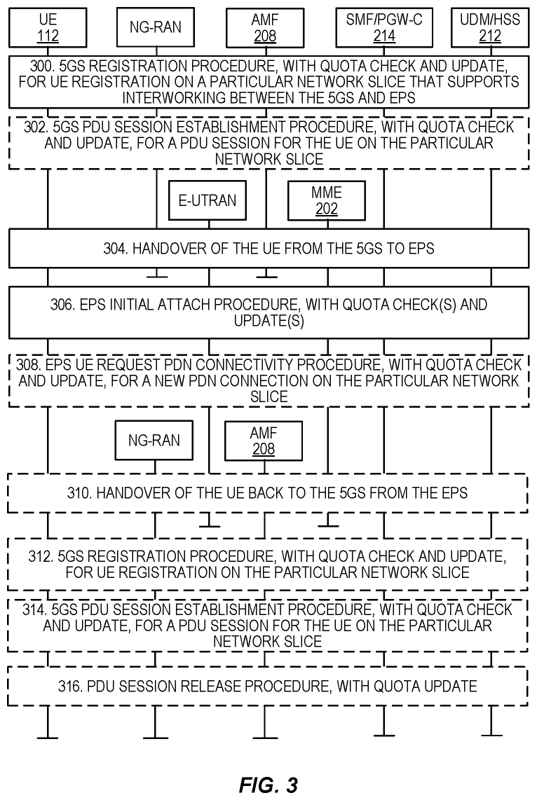

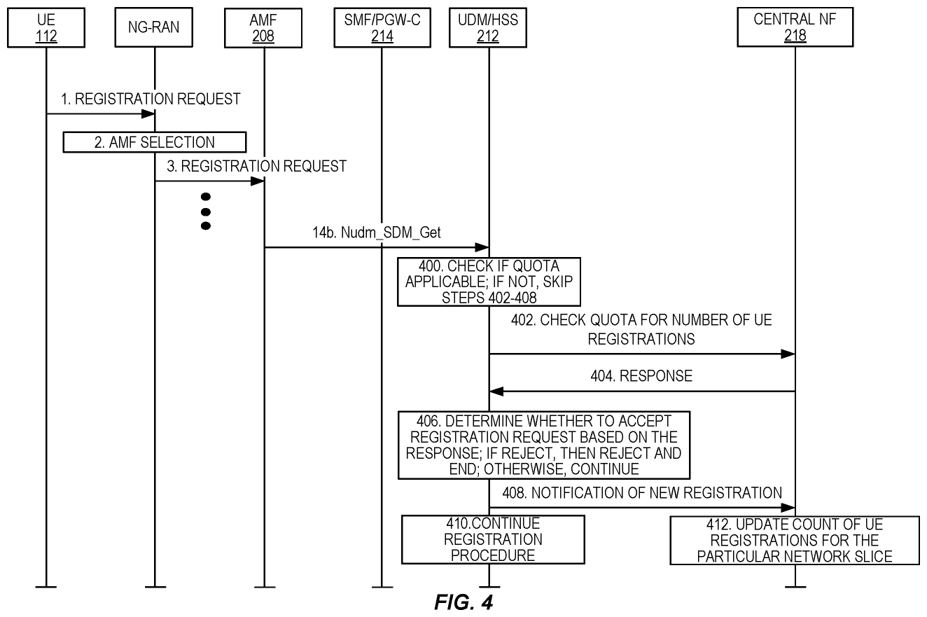

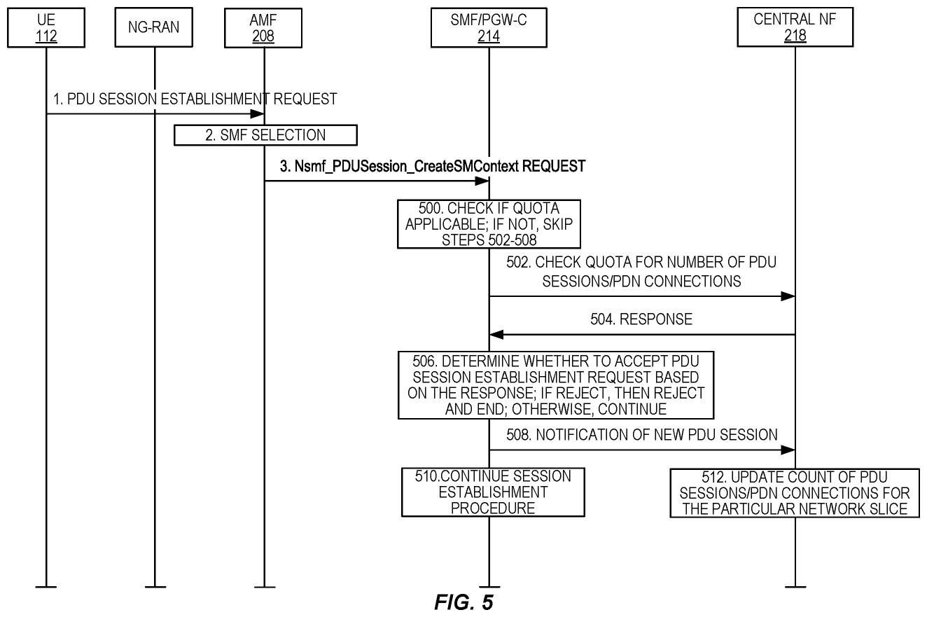

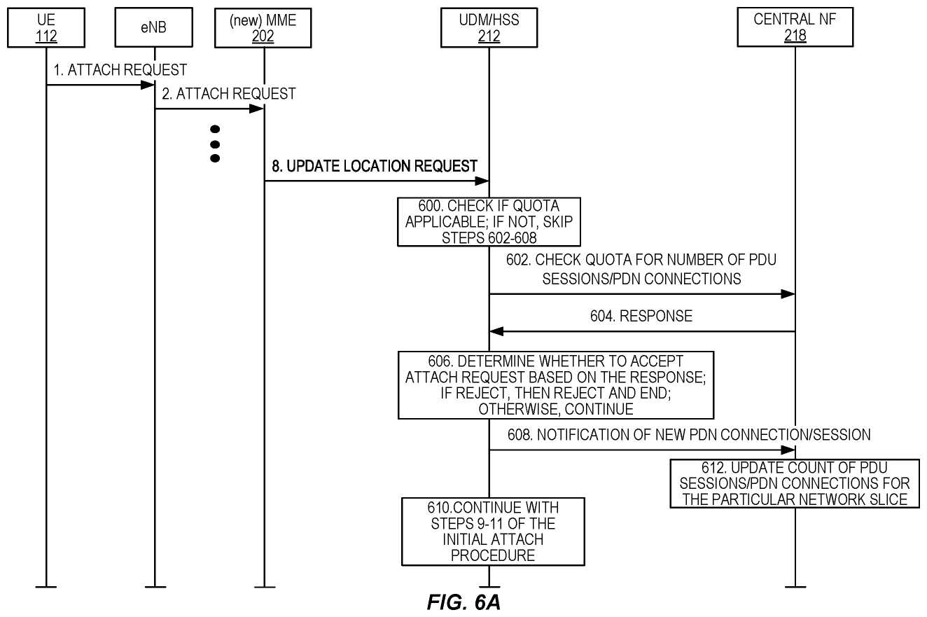

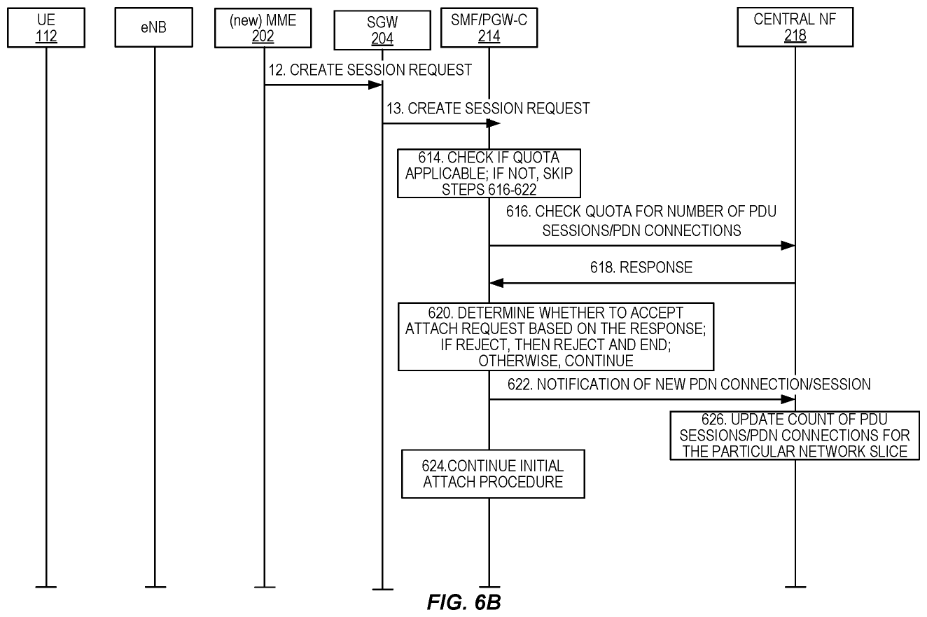

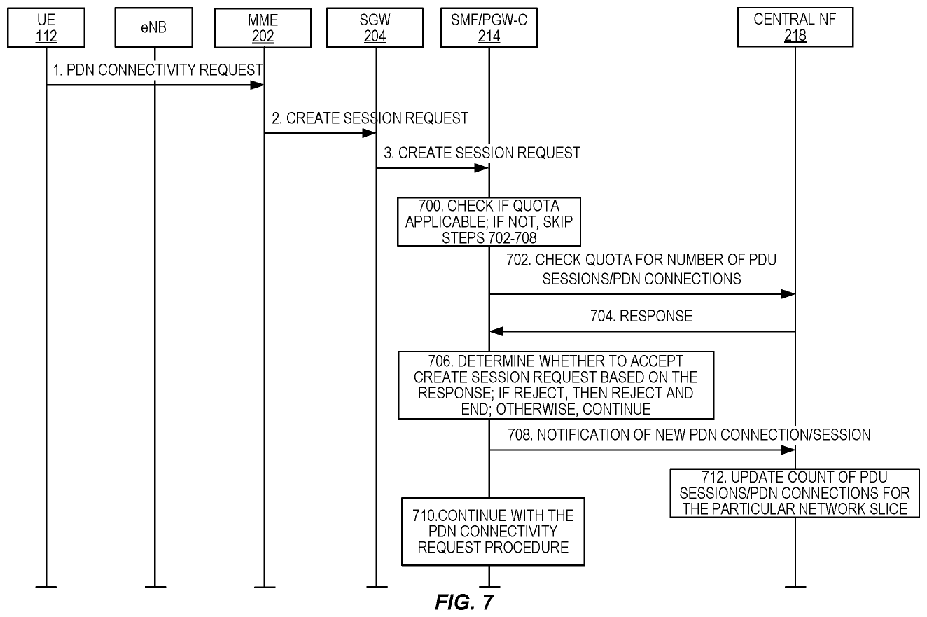

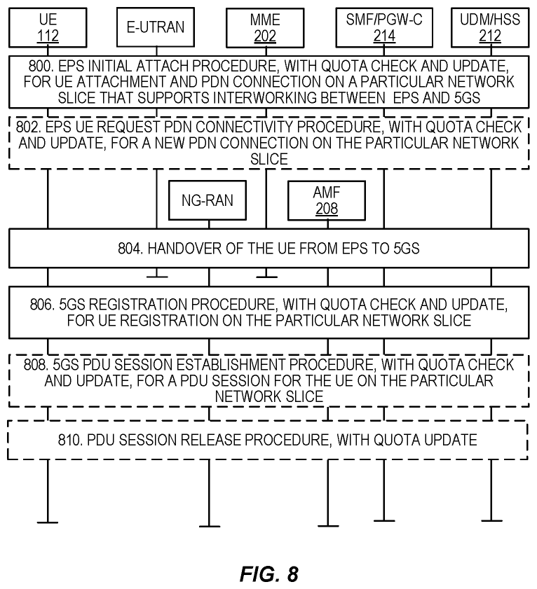

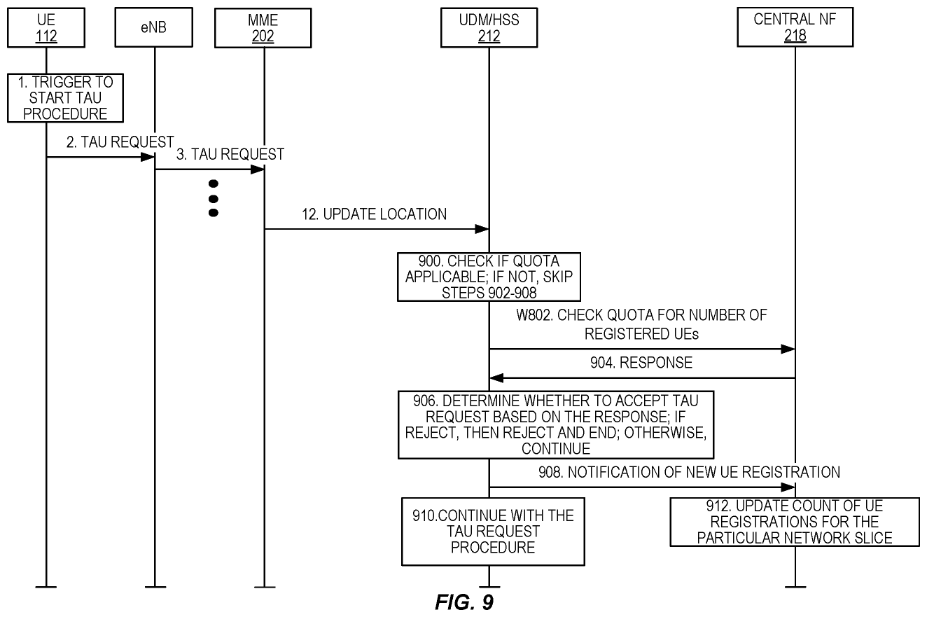

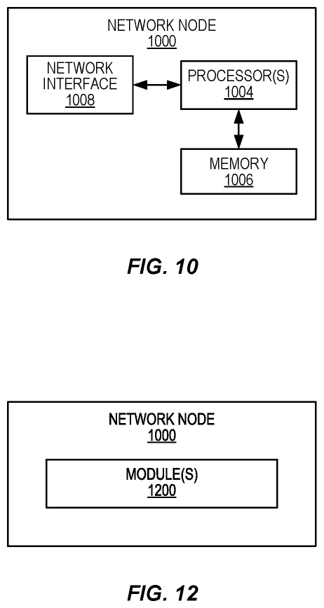

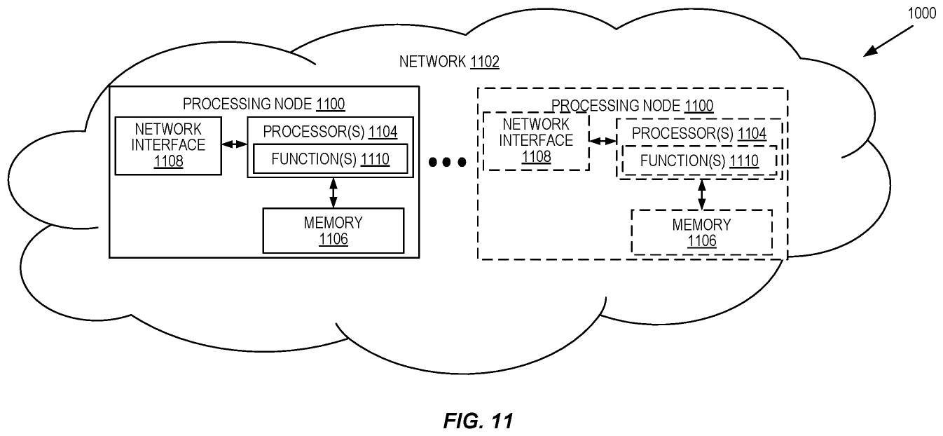

FIG. 8 illustrates a procedure similar to that of FIG. 3 in which the various procedures described above can be used in accordance with another example embodiment;

FIG. 9 illustrates a Tracking Area Update (TAU) procedure in which the UDM/HSS handles quotas for the number of registered UEs for a network slice in accordance with one embodiment of the present disclosure; and

FIGS. 10, 11, and 12 are schematic block diagrams of example embodiments of a network node in which embodiments of the present disclosure may be implemented.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

Certain aspects of the present disclosure and their embodiments may provide solutions to the aforementioned or other challenges. The present disclosure provides a solution to deal with network slices (e.g., Serving Network Slice Assistance Informations (S-NSSAIs) in the Fifth Generation System (5GS)) that: (1) are subject to a quota(s) (e.g., quota related to the number of UEs registered in the network slice and/or the number of Protocol Data Unit (PDU) sessions allowed for the network slice) and (2) do support Interworking (IWK) with the Evolved Packet System (EPS). The quota(s) include, in the example embodiments described herein, a quota(s) related to the number of UEs registered in an S-NSSAI and/or the number of PDU sessions allowed for an S-NSSAI.

Note that the terms “network slice” and “S-NSSAI” are used interchangeably herein particularly when referring to embodiments implemented in the 5GS. However, it is to be understood that a network slice is more precisely identified by the S-NSSAI in the subscription, in the network configuration, or in any signaling between the UE and the network. As such, when the description herein refers to, for example, a quota for an S-NSSAI, it should be understood that this quota is a quota for the network slice that is identified by the S-NSSAI.

### Handling of Quotas for Number of UEs Registered in an S-NSSAI

In some embodiments, a Unified Data Management (UDM) in the 5G core (5GC) applies a quota for a S-NSSAI(s) that is subject to (i.e., that supports) IWK with EPS regardless of whether the UE initially attaches to the EPS or initially registers in the 5GS. The Home Subscriber Server (HSS) in the Evolved Packet Core (EPC) does not apply any quota but interworks with the UDM for quota verification and application. In one embodiment, the UDM is stateful to quota application for S-NSSAIs

subject to IWK. Note that, for the embodiments described herein, there is at least one such S-NSSAI. If the UE registers in the 5GS, then the UDM checks its internal state to determine whether the quota for the number of registered UEs for the requested S-NSSAI has already been applied to the UE. In other words, the UDM checks whether the UE has already been counted toward the number of registered UEs for the requested S-NSSAI. This would be the case if, for example, the UE registration is a result of a scenario in which the UE initially registered in the 5GS, was handed over from the 5GS to the EPS, and subsequently handed back to the 5GS from the EPS. If the UE has not already been counted, the UDM performs a quota check procedure to determine whether the quota for the number of registered UEs for the S-NSSAI has been reached. If the quota has been reached, then the UE may not be permitted to register on the S-NSSAI. However, if the quota has not been reached, the UE registration to the S-NSSAI is allowed (such that the UE registration procedure continues), and the UDM increments the count, or causes the count to be incremented, for the number of UEs registered to the S-NSSAI. In one embodiment, the UDM interacts with a Central NF, which holds a Public Land Mobile Network (PLMN) quota balance for the S-NSSAI (and other S-NSSAIs subject to IWK), for the purpose of performing the quota check and incrementing the count of registered UEs. Note that if the UE has already been counted, then the quota check is not performed.

Option 1: If a UE attaches to EPS or initiates a Tracking Area Update (TAU) with subsequent update location by the Mobility Management Entity (MME) to HSS, then the HSS checks with the UDM for quota applicability and quota check. Given that the implied S-NSSAI to be used is not known at this point in time (i.e., not signaled to the HSS and also not signaled from the HSS to UDM), in one embodiment, the UDM performs a quota check on all S-NSSAIs subject to quota and IWK. For each S-NSSAI, the UDM checks its internal state to determine whether the UE has already been counted for this S-NSSAI. If the state indicates that the UE has already been counted for this S-NSSAI, then no further quota check or incrementing of the count of the number of registered UEs for this S-NSSAI is performed. If the UDM's internal state indicates that that UE has not already been counted for this S-NSSAI, then UDM performs a quota check for the S-NSSAI (by requesting a quota check from a Central NF holding the PLMN quota balance) prior to acceptance of the UE registration. In either case, the UDM responds to the HSS so the HSS can act accordingly.

Option 2: In this option, UE 5G registration can be, for example, any existing solution for 5G registration. For PDU Session/Packet Data Network (PDN) Connection quota (discussed below), a combined Session Management Function (SMF) and PDN Gateway Control plane (SMF+PGW-C) interacts with a Central NF handling the quota. The Central NF can be part of any NF that is decided to control the quota. Note that the SMF+PGW-C may also be referred to herein as a “SMF/PGW-C,” a “PGW-C+SMF,” or a “PGW-C/SMF.” It is assumed that it is mainly the SMF+PGW-C that is regarded to be in the Network Slice in 5GS and used when the UE is on EPS as a common anchor point while the other NFs of the EPS are regarded to be Network Slice independent and therefore there is no need to count at attachment, i.e. corresponding to 5GS Registration. For S-NSSAIs subject to IWK with EPS, the SMF+PGW-C sends a message to the Central NF when a PDU Session (in 5GS it can also be another NF reporting the number of PDU Sessions, e.g. the AMF, as long as the same Central NF maintains the knowledge) or PDN Connection is established and released. This message indicates one or more of the following: the UE identity, e.g. Subscription Permanent Identifier (SUPI); the S-NSSAI related to the PDU Session or PDN Connection; an indication of whether there is an establishment or release of a PDU Session or PDN Connection; and an indication of whether the UE is located in EPS or 5GS. The Central NF keeps a state per UE maintaining the following logic:
When the UE is in EPS,
   The SMF+PGW-C updates the Central NF with the S-NSSAIs that the UE uses when the UE is moved to EPS. But, if the same Central NF also maintains the count of number of PDU Sessions for a Network Slice and per UE, this is not needed as the Central NF already knows the number of PDU Sessions (PDN Connections) the UE uses. Note that every PDU session/PDN connection has an S-NSSAI related to it.
   The Central NF reduces the count for the number of UEs registered in an S-NSSAI when the last PDN Connection is released for the S-NSSAI for a UE.
   The Central NF increases the count for the number of UEs registered in an S-NSSAI when the first PDN Connection is established for the S-NSSAI for a UE while the UE is in EPS that was not counted for the UE while the UE was in 5GS.
When the UE moves to 5GS:
   The Central NF may be informed by an NF, e.g. AMF or SMF+PGW-C, that the UE entered 5GS. The Central NF then interacts with the SMF+PGW-C for quota checks and counting in relation to the operation of the UE in the 5GS. Note that, once the UE is counted towards the number of UEs registered for an S-NSSAI, the UE is not counted again for the same S-NSSAI when the UE moves from the EPS to the 5GS and vice versa. Likewise, when the respective PDU Session or PDN Connection in the 5GS or EPS is released, the count of the number of UEs registered to the S-NSSAI is decremented regardless of whether the UE is in the 5GS or the EPS at the time of release.

For both options, for S-NSSAIs that are not subject to IWK with EPS, 5G NFS, other than the UDM or SMF+PGW-C, can apply the quota. However, in this case, the central NF holding the PLMN quota balance is configured with the S-NSSAIs subject to IWK and those not subject to IWK. This enables the central NF to bypass quota verification for 5G network functions, other than UDM or PGW-C+SMF, initiating quota verification, when they are related to S-NSSAIs subject to IWK.

### Handling of Quotas for Number of PDU Sessions/PDN Connections for an S-NSSAI

In some embodiments, the SMF+PGW-C handles quotas for PDU sessions/PDN connections for S-NSSAIs subject to IWK. In one embodiment, the SMF+PGW-C is stateful to quota application for S-NSSAIs subject to IWK.

When the UE requests establishment of a PDN connection or a PDU session, the SMF+PGW-C checks its internal state for the UE against the S-NSSAI for which the PDN connection or PDU session is requested. If the state indicates that quota has been applied, nothing is done. The quota may have already been applied if the session is being handed over from 5GS to EPS or vice versa. If the state indicates that quota has not been applied, then the SMF+PGW-C performs a quota check for the number of PDU sessions or PDN connections for the S-NSSAI prior to permitting the request for establishment the PDU session or PDN connection. If the quota for the number of PDU sessions or PDN connections for the S-NSSAI has not been reached, the request is accepted, and the SMF+PGW-C increments, or causes to be incremented, the number of PDU sessions or PDN connection for the S-NSSAI. In one embodiment, the SMF+PGW-C interacts with the Central NF to perform the quota check and increment the counter. Subsequently, the SMF+PGW-C sets its internal state and provides a response to the NF from which it received the message that triggered to quota check procedure.

Embodiments of the solution described herein ensure that quotas are applied only once regardless of the UE starting point (EPS or 5GS).

For S-NSSAIs not subject to IWK, 5G Network Functions, other than SMF+PGW-C, can apply the quota. However, in this case, the central NF holding the PLMN quota balance is configured with the S-NSSAIs subject to IWK and those not subject to IWK. This enables the central NF to bypass quota verification for 5G network functions, other than SMF+PGW-C, initiating quota verification, when they are related to S-NSSAIs subject to IWK.

As an option, the PGW-C+SMF can report the events as per option 2 for “Handling of quotas for number of UE registered in an S-NSSAI,” and in such case the Central NF maintains also the count for “quotas for number of PDU sessions/PDN connection for an S-NSSAI.”

Certain embodiments may provide one or more of the following technical advantage(s). Quotas for network slices are an important feature, particularly when considering the numerous vertical applications that can potentially benefit from the use of network slices. Embodiments of the solution described herein provide an efficient mechanism for maintaining and using quotas for network slices that support interworking.

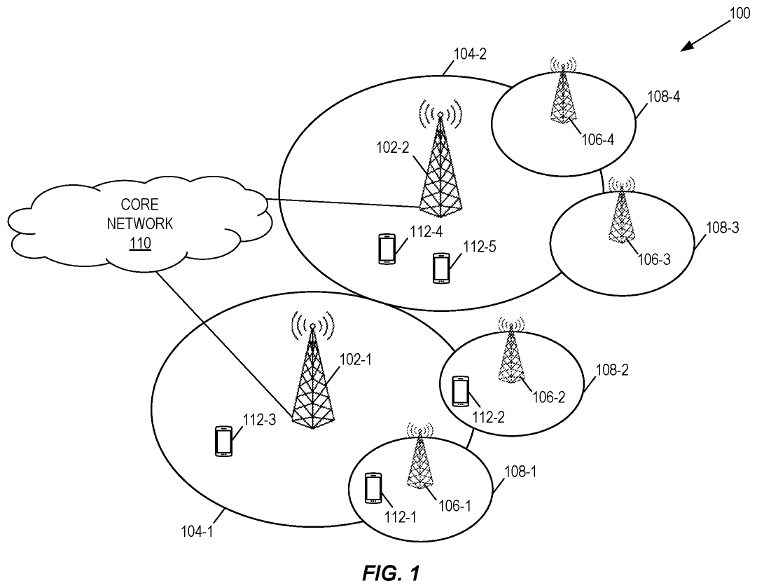

FIG. 1 illustrates one example of a cellular communications system 100 in which embodiments of the present disclosure may be implemented. In the embodiments described herein, the cellular communications system 100 is a system that enables interworking between a 5G system (5GS) including a Next Generation RAN (NG-RAN) and a 5G Core (5GC) and an Evolved Packet System (EPS) including an Evolved Universal Terrestrial RAN (E-UTRAN) and an Evolved Packet Core (EPC). In this example, the RAN includes base stations 102-1 and 102-2, which in the NG-RAN include NR base stations (gNBs) and optionally next generation eNBs (ng-eNBs) (e.g., LTE RAN nodes connected to the 5GC) and in the E-UTRAN include eNBs, controlling corresponding (macro) cells 104-1 and 104-2. The base stations 102-1 and 102-2 are generally referred to herein collectively as base stations 102 and individually as base station 102. Likewise, the (macro) cells 104-1 and 104-2 are generally referred to herein collectively as (macro) cells 104 and individually as (macro) cell 104. The RAN may also include a number of low power nodes 106-1 through 106-4 controlling corresponding small cells 108-1 through 108-4. The low power nodes 106-1 through 106-4 can be small base stations (such as pico or femto base stations) or Remote Radio

Heads (RRHs), or the like. Notably, while not illustrated, one or more of the small cells 108-1 through 108-4 may alternatively be provided by the base stations 102. The low power nodes 106-1 through 106-4 are generally referred to herein collectively as low power nodes 106 and individually as low power node 106. Likewise, the small cells 108-1 through 108-4 are generally referred to herein collectively as small cells 108 and individually as small cell 108. The cellular communications system 100 also includes a core network(s) 110, which in the 5G System (5GS) is referred to as the 5GC and in the EPS is referred to as the EPC. The base stations 102 (and optionally the low power nodes 106) are connected to the core network 110.

The base stations 102 and the low power nodes 106 provide service to wireless communication devices 112-1 through 112-5 in the corresponding cells 104 and 108. The wireless communication devices 112-1 through 112-5 are generally referred to herein collectively as wireless communication devices 112 and individually as wireless communication device 112. In the following description, the wireless communication devices 112 are oftentimes UEs, but the present disclosure is not limited thereto.

FIG. 2 illustrates one example of the cellular communications system 100 in which embodiments of the present disclosure may be implemented. In this example, the cellular communications system 100 includes both a 5GS and an EPS with interworking between the 5GS and EPS. As illustrated, in regard to the EPS, the cellular communications system 100 includes an E-UTRAN 200, which includes one or more base stations 102 that are, in this case, eNBs and a number of core network nodes of the EPC. As illustrated, the network nodes of the EPC include, in this example, an MME 202 and a SGW 204. In regard to the 5GS, the cellular communications system 100 includes a NG-RAN 206, which includes one or more base stations that are, in this case, gNBs or ng-eNBs and a number of NFs of the 5GC. As illustrated, the NFs include an AMF 208 and a PCF 210. In addition, to enable interworking between the 5GS and the EPS, the cellular communications system 100 includes a number of combined, or joint, NFs. The combined NFs include, in this example, a combined HSS and UDM 212 (also referred to herein as HSS+UDM 212 or HSS/UDM 212), a combined SMF and PGW-C 214 (also referred to herein as a SMF+PGW-C 214 or SMF/PGW-C 214), and a combined UPF and PGW-U 216 (also referred to herein as a UPF+PGW-U 216 or UPF/PGW-U 216). In some embodiments of the present disclosure, the SMF+PGW-C 214 interacts with a Central NF 218 to handle quotas for the number of PDU sessions or PDN connections for a network slice (S-NSSAI) and/or quotas for the number of registered UEs 112 for a network slice.

Details of some example embodiments of the present disclosure that implement aspects of the embodiments described above will now be described.

FIG. 3 illustrates the operation of the cellular communications system 100 of FIG. 2 in accordance with an example embodiment of the present disclosure. Optional steps are represented by dashed lines/boxes. Note that this example is only intended to show an example of a framework for various procedures in which a quota check is performed and the counts updated for a network slice subject to interworking. However, it should be appreciated that these procedures are not limited to the example embodiment of FIG. 3.

In this example, a UE 112 initially registers with the 5GS via a 5G registration procedure (step 300). The registration is for a particular network slice, which is indicated by a particular S-NSSAI. The 5G registration procedure includes, in this example, a quota check for the number of UEs registered with the particular network slice before accepting the registration and, if accepted, updating of the count of the number of UEs registered for the particular network slice accordingly. Details of the 5G registration procedure are discussed below in regard to FIG. 4.

After registering with the 5GS for the particular network slice, the UE 112 may also request establishment of a PDU session on the network slice, where this PDU session is established via a PDU session establishment procedure (step 302). The PDU session procedure includes, in this example, a quota check for the number of PDU sessions/PDN connections for the particular network slice before accepting the request for establishment of the PDU session. If accepted, the PDU session establishment procedure includes a mechanism for updating the count of the number of PDU sessions/PDN connections for the particular network slice. Details of the PDU session establishment procedure are discussed below in regard to FIG. 5.

In this example, at some point, the UE 112 is handed over from the 5GS to the EPS (step 304). After handover or in association with the handover, an EPS initial attach procedure is performed (step 306). In this example, the EPS initial attach procedure includes a procedure for determining whether the quota check(s) needs to be performed (e.g., have they already been performed for the UE 112 for the particular network slice). If quota check(s) is(are) needed, a quota check for the number of UE registered for the particular network slice and/or a quota check for the number of PDU sessions/PDN connection for the particular network slice is(are) performed. In regard to the quota check for the number of registered UEs, since the UE 112 is already counted in the number of registered UEs for the particular network slide during the 5G registration procedure of step 300, a determination is made that the quota check for the number of registered UEs does not need to be performed. As such, this quota check is skipped. In regard to the quota check for the number of PDU sessions/PDN connections, if the UE 112 did not establish a PDU session when in the 5GS (e.g., if step 302 was not performed), then the quota check for the number of PDU sessions/PDN connections is performed before establishing a PDN connection during the initial attach procedure. If the quota check allows the PDN connection, then the count of the number of PDU sessions/PDN connections is updated accordingly. Details of the EPS initial attach procedure are discussed below in regard to FIGS. 6A and 6B.

The UE 112 may also initiate a PDN connection via a UE request PDN connectivity procedure (step 308). This procedure may also include a check for quota applicability and, if applicable, the quota check(s) and, if allowed, the updating of the respective count. Details of the UE request PDN connectivity procedure are discussed below in regard to FIG. 7.

At some point, the UE 112 may be handed back to the 5GS (step 310). After or in association with the handover, a 5G registration procedure is performed (step 312). In this procedure, since the UE 112 has already been counted towards the number of registered UEs for the particular network slice, the quota check for the number of registered UEs for the particular network slice can be skipped and the UE 112 is not again counted towards the number of registered UEs for the network slice. In a similar manner, a PDU session establishment procedure (PDU session handover) is performed (step 314). However, since the session of the UE 112 has already been counted towards the number of PDU sessions/PDN connections for the particular network slice, the quota check can be skipped and the PDU session is not again counted towards the number of PDU sessions/PDN connections for the network slice. As a general rule, new sessions/connections are counted once and never counted subsequently when then they are handover either direction. The same for registration/attachment and regardless of the UE initial start.

At some point, the session of the UE 112 is released (step 316). In this case, the count of the number of PDU sessions/PDN connections for the network slice is decremented.

FIG. 4 illustrates a 5G UE registration procedure in which the UDM/HSS 212 handles quotas for the number of UEs registered for a network slice (S-NSSAI) in accordance with one embodiment of the present disclosure. Details regarding the conventional 5G UE registration procedure can be found in Section 4.2.2.2.2 of 3GPP TS 23.502 V16.4.0. The description below focuses on news steps added to the conventional PDU Session Establishment procedure in which the SMF+PGW-C 214 handles quotas for the number of PDU sessions or PDN connections for a network slice (S-NSSAI). While not necessary for understanding the solution, the interested reader is directed to Section 4.2.2.2.2 of 3GPP TS 23.502 V16.4.0 for the details of steps other than steps 400-412.

The UE 112 sends a registration request to the NG-RAN (step 1). The registration request includes an identity (SUPI) of the UE 112 and the S-NSSAI of the requested network slice. The NG-RAN performs an AMF selection procedure (step 2). The NG-RAN sends the registration request to the selected AMF, which in this example is the AMF 208. The registration procedure continues until the AMF 208 sends a Nudm_SDM_Get message to the UDM/HSS 212 (step 14b). This message includes the S-NSSAI and the identity of the UE 112.

Steps 400-412 illustrate one example embodiment of a process by which the UDM/HSS 212 determines whether the quota is applicable and, if so, performs the quota check and updates the respective count, if needed. More specifically, the UDM/HSS 212 determines whether a quota for the number of registered UEs is to be applied for the UE 112 for the requested S-NSSAI (step 400). In one embodiment, the UDM/HSS 212 does so by determining whether the S-NSSAI is a slice that supports IWK and is subject to a quota for the number of registered UEs. If so, the UDM 212 checks its internal state to determine whether the UE 112 has already been counted towards the number of registered UEs for the S-NSSAI. If the UDM 212 determines that the UE 112 has not yet been counted (e.g., if the UDM 212 determines that it does not have an internal quota state for the UE 112 for this S-NSSAI) and this registration is for a S-NSSAI subject to IWK, then the UDM 212 applies the quota against the S-NSSAI. The UDM interacts with the central NF 218 holding the PLMN quota for that purpose. If there are no more quotas available, UDM indicates this to AMF to reject the 5G Registration. If there is internal state held by the UDM indicating quota validated for that UE against the S-NSSAI, UDM does not apply quota.

More specifically, in the illustrated embodiment, the UDM/HSS 222 performs the quota check and adjusts the counter if needed as follows. Note, however, that the quota check and counter adjustment may alternatively be performed by, e.g., the AMF. The UDM/HSS 212 sends a message to the Central NF 218 that requests a quota check for the number of registered UEs for the S-NSSAI (step 402). The Central NF 218 responds with a message that indicates whether or not the quota has been reached (step 404). The UDM/HSS 212 determines whether to accept or reject the UE registration for the S-NSSAI based on the response from the Central NF (step 306). If the quota has been reached, then the UE registration request may be rejected. If the quota has not been reached, the UDM/HSS 212 determines that the UE registration request is to be accepted and informs the Central NF 218 of a new UE registration for the S-NSSAI (step 408). The UDM/HSS 212 continues the (conventional) UE registration procedure (step 410). The Central NF 218 increments the count of the number of registered UEs for the S-NSSAI in response to the notification of step 408 (step 412). Note that while the Central NF 218 maintains the count in this example, the present disclosure is not limited thereto. In one example alternative embodiment, the count is maintained by the UDM/HSS 212, where the UDM/HSS 212 interacts with the Central NF 218 to determine whether the quota has been reached and, if not, the UDM/HSS 212 increments the count of the number of registered UEs. Also note that the count may alternatively be a count of the number of registered UEs remaining in the quota (i.e., how many more UE can be registered), in which case the counter would be decremented upon determining that the quota has not been reached and therefore determining to accept the registration request.

FIG. 5 illustrates a PDU Session Establishment procedure in which the SMF+PGW-C 214 handles quotas for the number of PDU sessions or PDN connections for a network slice (S-NSSAI) in accordance with one embodiment of the present disclosure. Details regarding the conventional PDU Session Establishment procedure can be found in Section 4.3.2.2.1 of 3GPP TS 23.502 V16.4.0. The description below focuses on news steps added to the conventional PDU Session Establishment procedure in which the SMF+PGW-C 214 handles quotas for the number of PDU sessions or PDN connections for a network slice (S-NSSAI). While not necessary for understanding the solution, the interested reader is directed to Section 4.3.2.2.1 of 3GPP TS 23.502 V16.4.0 for the details of steps other than steps 500-512.

The UE 112 sends a PDU Session Establishment Request to the AMF 208 (step 1). The PDU Session Establishment Request includes the S-NSSAI of the network slice for which the UE 112 is requesting PDU session establishment. The AMF 208 performs SMF selection to thereby select the SMF+PGW-C 214 (step 2). The AMF 208 sends a Nsmf_PDUSession_CreateSMContext Request to the SMF+PGW-C 214, which includes the S-NSSAI from the PDU Session Establishment Request of step 1 (step 3).

Steps 500-512 illustrate one example embodiment of a process by which the SMF+PGW-C 214 determines whether the quota is applicable and, if so, performs the quota check and updates the respective count, if needed. More specifically, the SMF+PGW-C 214 determines whether a quota checks is needed (step 500). In one embodiment, the SMF+PGW-C 214 determines whether the S-NSSAI is subject to interworking and subject to a quota for the number of PDU sessions/PDN connections. If so, the SMF+PGW-C 214 performs a quota check procedure. In one embodiment of step 400, the SMF-PGW-C 214 checks its internal state. If the SMF+PGW-C 214 does not have an internal quota state for the session of the UE 112 for the S-NSSAI, then the SMF+PGW-C 214 determines that a quota check is to be performed for the S-NSSAI. For example, in one embodiment, the Nsmf_PDUSession_CreateSMConext Request includes a session ID that applies to the session regardless of whether the session is a PDU session in the 5GS or a PDN connection in the EPS. This session ID can then be used by the SMF+PGW-C 214 to determine whether the session ID has already been counted towards the number of PDU sessions/PDN connections for the S-NSSAI. In one embodiment, the SMF+PGW-C 214 interacts with the central NF 218 holding the PLMN quota(s) for the purpose of applying the quota(s). If there is no more quota available (i.e., if the quota(s) has been reached for the S-NSSAI), the SMF+PGW-C 214 may reject the PDU session establishment. If there is an internal state held by the SMF+PGW-C 214 indicating that the quota has already been validated for the UE 112 against the S-NSSAI, then normal session establishment continues (i.e., the procedure continues to steps 4-21).

More specifically, in the illustrated embodiment, the SMF+PGW-C 214 performs the quota check by sending a message to the Central NF 218 that requests a quota check for the number of PDU sessions/PDN connections for the S-NSSAI (step 502). The Central NF 218 responds with a message that indicates whether or not the quota has been reached (step 504). The SMF+PGW-C 214 determines whether to accept or reject the PDU session establishment request based on the response from the Central NF (step 406). If the quota has been reached, then the PDU session establishment request may be rejected. If the quota has not been reached, the SMF+PGW-C 214 determines that the PDU session establishment request is to be accepted and informs the Central NF 218 of a new PDU session being established for the S-NSSAI (step 508). The SMF+PGW-C 214 updates its internal state to reflect that this PDU session of the UE 112 for the S-NSSAI has been counted towards the number of PDU sessions/PDN connections for the S-NSSAI. The SMF+PGW-C 214 continues the (conventional) PDU session establishment procedure (step 510). The Central NF 218 increments the count of the number of PDU sessions/PDN connections for the S-NSSAI in response to the notification of step 508 (step 512). Note that the use of the Central NF 218 avoids the need to select the same PGW-C+SMF for all PDU Sessions for the same S-NSSAI and enables the Central NF 218 to know the number of PDU Sessions used per S-NSSAI and per UE. Also note that while the Central NF 218 maintains the count in this example, the present disclosure is not limited thereto. In one example alternative embodiment, the count is maintained by the SMF+PGW-C 214, where the SMF+PGW-C 214 interacts with the Central NF 218 to determine whether the quota has been reached and, if not, the SMF+PGW-C 214 increments the count of the number of PDU sessions/PDN connections for the S-NSSAI. Also note that the count may alternatively be a count of the number of PDU sessions/PDN connections remaining in the quota (i.e., how many more PDU sessions or PDN connections can be added), in which case the counter would be decremented upon determining that the quota has not been reached and therefore determining to accept the request.

In support of option 2 described above for maintaining the count of number of registered UEs, the SMF+PGW-C 214 can report the events to a Central NF 218 that maintains the count. This avoids the need to select the same SMF+PGW-C 214 for all PDU Sessions for the same S-NSSAI, and enables the Central NF 218 to know the number of PDU Sessions used per S-NSSAI and per UE.

FIGS. 6A and 6B illustrate an EPS initial attach procedure in which the UDM/HSS 212 handles quotas for the number of registered UEs for a network slice (S-NSSAI) and/or the SMF+PGW-C 214 handles quotas for the number of PDU sessions or PDN connections for a network slice (S-NSSAI) in accordance with one embodiment of the present disclosure. Note, however, that the SMF+PGW-C may alternatively handle both the registration quota and the quota for the number of PDU sessions or PDN connections for a network slice (S-NSSAI). Details regarding the conventional EPS initial attach procedure can be found in Section 5.3.2 of 3GPP TS 23.401 V16.6.0. The description below focuses on new steps added to the conventional EPS initial attach procedure in which the quota(s) are handled for a network slice (S-NSSAI) that supports interworking between 5GS and EPS. While not necessary for understanding the solution, the interested reader is directed to Section 5.3.2 of 3GPP TS 23.401 V16.6.0 for the details of steps other than steps 600-612 and steps 614-624.

As illustrated, the UE 112 sends an attach request to the base station 102 (eNB) (step 1). The base station 102 sends the attach request to the MME 202 (step 2). The initial attach procedure continues until the MME 202 sends an update location request to the UDM/HSS 212 (step 8). The location request includes an identity of the UE 112.

Steps 600-612 illustrate one example embodiment of a process by which the UDM/HSS 212 determines whether the quota is applicable and, if so, performs the quota check and updates the respective count, if needed. More specifically, the UDM/HSS 212 determines whether a quota is to be applied (step 600). In one embodiment, the HSS checks with the UDM for quota (Subscription in HSS includes an indication that this check is necessary, and UDM may respond that quota handling is not applicable for this UE 112). Given that the implied S-NSSAI to be used is not known at this point in time, the UDM determines whether to perform a quota check on all S-NSSAIs subject to quota and IWK as well. For each S-NSSAI, the UDM checks for an internal quota state for the UE 112 for this S-NSSAI. If the UDM does not have an internal quota state and this attach is for an S-NSSAI subject to IWK, then UDM applies the quota against the S-NSSAI. UDM interacts with the central NF holding the PLMN quota for that purpose. If there are no more quotas available, UDM indicates this to HSS which may reject the attachment (or may take some other action), otherwise the attachment is accepted. If there is internal state held by the UDM indicating quota validated for that UE against the S-NSSAI, then UDM indicates that to HSS.

More specifically, in the illustrated embodiment once the UDM determines that a quota check is to be performed, the UDM/HSS 212 sends a message to the Central NF 218 that requests a quota check for the number of registered UEs for the S-NSSAI (step 602). The Central NF 218 responds with a message that indicates whether or not the quota has been reached (step 604). The UDM/HSS 212 determines whether to accept or reject the UE attach request for the S-NSSAI based on the response from the Central NF (step 506). If the quota has been reached, then the UE registration request may be rejected. If the quota has not been reached, the UDM/HSS 212 determines that the UE registration request is to be accepted and informs the Central NF 218 of a new UE registration for the S-NSSAI (step 608). The UDM/HSS 212 continues the (conventional) UE registration procedure (step 610). The Central NF 218 increments the count of the number of registered UEs for the S-NSSAI in response to the notification of step 608 (step 612). Note that while the Central NF 218 maintains the count in this example, the present disclosure is not limited thereto. In one example alternative embodiment, the count is maintained by the UDM/HSS 212, where the UDM/HSS 212 interacts with the Central NF 218 to determine whether the quota has been reached and, if not, the UDM/HSS 212 increments the count of the number of registered UEs. Also note that the count may alternatively be a count of the number of registered UEs remaining in the quota (i.e., how many more UE can be registered), in which case the counter would be decremented upon determining that the quota has not been reached and therefore determining to accept the registration request.

The initial attach procedure continues until the MME 202 sends a create session request to the SGW 204 (step 12), and the SGW 204 sends the create session request to the SMF+PGW-C 214 (step 13). Steps 614-626 illustrate one example embodiment of a process by which the SMF+PGW-C 214 determines whether a quota for the number of PDU sessions/PDN connections for the S-NSSAI is applicable and, if so, performs a quota check and updates the respective count, if needed. More specifically, the SMF+PGW-C 214 determines whether the S-NSSAI is subject to IWK and subject to a quota for the number of PDU sessions/PDN connections (step 614). If so, SMF+PGW-C 214 performs a quota check procedure. In one embodiment of step 614, the SMF+PGW-C 214 checks its internal state. If the SMF+PGW-C 214 does not have an internal quota state for the session of the UE 112 for the S-NSSAI, then the SMF+PGW-C 214 determines that a quota check is to be performed for the S-NSSAI.

For example, in one embodiment, the Create Session Request includes a session ID that applies to the session regardless of whether the session is a PDU session in the 5GS or a PDN connection in the EPS. This session ID can then be used by the SMF+PGW-C 214 to determine whether the session ID has already been counted towards the number of PDU sessions/PDN connections for the S-NSSAI. In one embodiment, the SMF+PGW-C 214 interacts with the central NF 218 holding the PLMN quota for that purpose. If there is no more quota available, PGW-C+SMF may reject the Create Session Request. If there is internal state held by the PGW-C+SMF indicating quota validated for that UE against the S-NSSAI, then normal PDN connection continues.

More specifically, in the illustrated embodiment, the SMF+PGW-C 214 performs the quota check by sending a message to the Central NF 218 that requests a quota check for the number of PDU sessions/PDN connections for the S-NSSAI (step 616). The Central NF 218 responds with a message that indicates whether or not the quota has been reached (step 618). The SMF+PGW-C 214 determines whether to accept or reject the attach request based on the response from the Central NF (step 520). If the quota has been reached, then the request is rejected. If the quota has not been reached, the SMF+PGW-C 214 determines that the request is to be accepted and informs the Central NF 218 of a new PDN connection being established for the S-NSSAI (step 622). The SMF+PGW-C 214 continues the (conventional) attach procedure (step 624). The Central NF 218 increments the count of the number of PDU sessions/PDN connections for the S-NSSAI in response to the notification of step 620 (step 626). Note that while the Central NF 218 maintains the count in this example, the present disclosure is not limited thereto. In one example alternative embodiment, the count is maintained by the SMF+PGW-C 214, where the SMF+PGW-C 214 interacts with the Central NF 218 to determine whether the quota has been reached and, if not, the SMF+PGW-C 214 increments the count of the number of PDU sessions/PDN connections for the S-NSSAI. Also note that the count may alternatively be a count of the number of PDU sessions/PDN connections remaining in the quota (i.e., how many more PDU sessions or PDN connections can be added), in which case the counter would be decremented upon determining that the quota has not been reached and therefore determining to accept the request.

In support of option 2 described above for maintaining the count of number of registered UEs, the SMF+PGW-C 214 can report the events to the Central NF 218 that maintains the count. This avoids the need to select the same SMF+PGW-C 214 for all PDN Connections for the same S-NSSAI. The Central NF 218 keeps the count for number of UEs using a Network Slice and, when the Central NF 218 gets a new event from the SMF+PGW-C 214, the Central NF 218 increases the count for the first established PDN Connection event for a UE and does not increase the count if the same UE establishes a new PDN Connection for the same Network Slice, and in the similar way, for PDN Connections Release the Central NF decreases the count when a UE releases the last PDN Connection for the Network Slice.

FIG. 7 illustrates a UE requested PDN connectivity procedure in which the SMF+PGW-C 214 handles quotas for the number of PDU sessions or PDN connections for a network slice (S-NSSAI) in accordance with one embodiment of the present disclosure. Details regarding the conventional UE requested PDN connectivity procedure can be found in Section 6 of 3GPP TS 24.301 V 16.5.1. The description below focuses on news steps added to the conventional UE requested PDN connectivity procedure in which the SMF+PGW-C 214 handles quotas for the number of PDU sessions or PDN connections for a network slice (S-NSSAI). While not necessary for understanding the solution, the interested reader is directed to Section 6 of 3GPP TS 24.301 V 16.5.1 for the details of steps other than steps 700-712.

The UE 112 sends a PDN connectivity request to the MME 202 (step 1). The MME 202 sends a create session request to the SGW 204 (step 2), the SGW 204 sends the create session request to the SMF+PGW-C 214 (step 3). Steps 700-702 illustrate one example embodiment of a process by which the SMF+PGW-C 214 determines whether a quota for the number of PDU sessions/PDN connections for the S-NSSAI is applicable and, if so, performs a quota check and updates the respective count, if needed. More specifically, the SMF+PGW-C 214 determines whether a quota check is needed (step 700). In one embodiment, the SMF+PGW-C 214 determines whether the S-NSSAI is subject to IWK and subject to quotas. If so, the SMF+PGW-C 214 performs a quota check procedure. In one embodiment of step 700, the SMF+PGW-C 214 checks its internal state. If the SMF+PGW-C 214 does not have an internal quota state for the UE 112 for the S-NSSAI, then the SMF+PGW-C 214 determines that a quota check is to be performed for the number of PDU sessions/PDN connections for the S-NSSAI. For example, in one embodiment, the Create Session Request includes a session ID that applies to the session regardless of whether the session is a PDU session in the 5GS or a PDN connection in the EPS. This session ID can then be used by the SMF+PGW-C 214 to determine whether the session ID has already been counted towards the number of PDU sessions/PDN connections for the S-NSSAI. In one embodiment, the SMF+PGW-C 214 interacts with the central NF 218 holding the PLMN quota for that purpose. If there is no more quota available, the SMF+PGW-C 214 rejects the create session request. If there is internal state held by the PGW-C+SMF indicating quota validated for that UE against the S-NSSAI, then normal session establishment continues.

More specifically, in the illustrated embodiment, the SMF+PGW-C 214 performs the quota check by sending a message to the Central NF 218 that requests a quota check for the number of PDU sessions/PDN connections for the S-NSSAI (step 702). The Central NF 218 responds with a message that indicates whether or not the quota has been reached (step 704). The SMF+PGW-C 214 determines whether to accept or reject the request based on the response from the Central NF (step 606). If the quota has been reached, then the request may be rejected. If the quota has not been reached, the SMF+PGW-C 214 determines that the request is to be accepted and informs the Central NF 218 of a new PDN connection being established for the S-NSSAI (step 708). The SMF+PGW-C 214 continues the (conventional) UE requested PDN connectivity procedure (step 710). The Central NF 218 increments the count of the number of PDU sessions/PDN connections for the S-NSSAI in response to the notification of step 708 (step 712). Note that while the Central NF 218 maintains the count in this example, the present disclosure is not limited thereto. In one example alternative embodiment, the count is maintained by the SMF+PGW-C 214, where the SMF+PGW-C 214 interacts with the Central NF 218 to determine whether the quota has been reached and, if not, the SMF+PGW-C 214 increments the count of the number of PDU sessions/PDN connections for the S-NSSAI. Also note that the count may alternatively be a count of the number of PDU sessions/PDN connections remaining in the quota (i.e., how many more PDU sessions or PDN connections can be added), in which case the counter would be decremented upon determining that the quota has not been reached and therefore determining to accept the request.

In support of option 2 described above for maintaining the count of number of registered UEs, the SMF+PGW-C 214 can report the events to the Central NF 212 that maintains the count. This avoids the need to select the same SMF+PGW-C 214 for all PDN Connections for the same S-NSSAI. The Central NF 218 keeps the count for number of UEs using a Network Slice and when the Central NF 218 gets a new event from the SMF+PGW-C 214, the Central NF 218 increases the count for the first established PDN Connection event for a UE. The Central NF 218 does not increase the count if the same UE establishes a new PDN Connection for a Network Slice it has already an PDN connection in, and in the similar way, for PDN Connections Release the Central NF decreases the count when a UE releases the last PDN Connection for the Network Slice.

FIG. 8 illustrates a procedure similar to that of FIG. 3 in which the various procedures described above can be used in accordance with another example embodiment. In this example, the UE 112 starts in the EPS, rather than in the 5GS. In this example, a UE 112 initially attaches to the EPS via an EPS initial attach procedure (step 800). The attach is for a particular network slice, which is indicated by a particular S-NSSAI. The EPS initial attach procedure includes, in this example, a quota check for the number of UEs registered with the particular network slice before accepting the attach and, if accepted, updating of the count of the number of UEs registered for the particular network slice accordingly.

After attaching to the EPS for the particular network slice, the UE 112 may also request establishment of a PDN connection on the network slice, where this PDN connection is established via a PDN connectivity procedure (step 802). The PDN connectivity procedure includes, in this example, a quota check for the number of PDU sessions/PDN connections for the particular network slice before accepting the request for establishment of the PDN connection. If accepted, the PDN connectivity procedure includes a mechanism for updating the count of the number of PDU sessions/PDN connections for the particular network slice.

In this example, at some point, the UE 112 is handed over from the EPS to the 5GS (step 804). After handover or in association with the handover, a 5GS registration procedure is performed (step 806). In this example, the 5GS registration procedure includes a procedure for determining whether the quota check(s) needs to be performed (e.g., have they already been performed for the UE 112 for the particular network slice). If quota check(s) is(are) needed, a quota check for the number of UE registered for the particular network slice and/or a quota check for the number of PDU sessions/PDN connections for the particular network slice is(are) performed. In regard to the quota check for the number of registered UEs, since the UE 112 is already counted in the number of registered UEs for the particular network slide during the EPS attach procedure of step 800, a determination is made that the quota check for the number of registered UEs does not need to be performed. As such, this quota check is skipped. In regard to the quota check for the number of PDU sessions/PDN connections, if the UE 112 did not establish a PDN connection when in the EPS (e.g., if step 802 was not performed), then the quota check for the number of PDU sessions/PDN connections is performed before establishing a PDU session during the 5GS registration procedure. If the quota check allows the PDU session, then the count of the number of PDU sessions/PDN connections is updated accordingly.

The UE 112 may also initiate a PDU session via a UE requested PDU session establishment procedure (step 808). This procedure may also include a check for quota applicability and, if applicable, the quota check(s) and, if allowed, the updating of the respective count.

At some point, the PDU session of the UE 112 is released (step 810). In this case, the count of the number of PDU sessions/PDN connections for the network slice is decremented.

FIG. 9 illustrates a Tracking Area Update (TAU) procedure in which the UDM/HSS 212 handles quotas for the number of registered UEs for a network slice (S-NSSAI) in accordance with one embodiment of the present disclosure. Details regarding the conventional TAU procedure can be found in Section 5 of 3GPP TS 24.301 V 16.5.1. The description below focuses on news steps added to the conventional TAU procedure in which the UDM/HSS 214 handles quotas for the number of registered UEs for a network slice (S-NSSAI). While not necessary for understanding the solution, the interested reader is directed to Section 5 of 3GPP TS 24.301 V16.5.1 for the details of steps other than steps 900-912.

As illustrated, the UE 112 detects a trigger for a TAU (step 1). In response, the UE 112 sends a TAU request to the base station 102 (eNB) (step 2), and the base station 102 sends the TAU request to the MME 202 (step 3). The TAU procedure continues until the MME 202 sends an update location request to the UDM/HSS 212 (step 12). The UDM/HSS 212 then determines whether the quota is applicable and, if so, performs the quota check and updates the respective count, if needed (steps 900-912). The details of steps 900-912 are the same as those described above for similar steps of other procedures and, as such, not repeated here.

Some additional aspects of the solution described herein relate to updating the count(s) upon release of a PDU session/PDN connection and/or upon deregistration or detachment. In regard to release of a PDU session/PDN connection, for the purpose of quota management and in these cases, the SMF+PGW-C 214 validates if the S-NSSAI is subject to IWK and subject to quotas. If so, the SMF+PGW-C 214 checks its internal state. If the SMF+PGW-C 214 does not have an internal quota state, then the SMF+PGW-C 214 interacts with the central NF 218 holding the PLMN quota for that purpose to release the quota and updates its internal state accordingly.

As an option, the SMF+PGW-C 214 can report the events to the Central NF 218 that maintains the count. This avoids the need to select the same SMF+PGW-C 214 for all PDU Sessions for the same S-NSSAI.

In support of option 2 described above for maintaining the count of number of registered UEs, the SMF+PGW-C 214 can report the events to a Central NF 218 that maintains the count. This avoids the need to select the same SMF+PGW-C 214 for all PDN Connections for the same S-NSSAI. The Central NF 218 keeps the count for number of UEs using a Network Slice and when the Central NF 218 gets a new event from the SMF+PGW-C 214, the Central NF 218 increases the count for the first established PDN Connection event for a UE and does not increase the count if the same UE establishes a new PDN Connection for the same Network Slice, and in the similar way, for PDN Connections Release the Central NF decreases the count when a UE releases the last PDN Connection for the Network Slice.

In regarding to deregistration or detachment, at 5GC deregistration, if the

UDM determines that the S-NSSAI slice to be used for IWK is subject to quota, it checks first its internal state. If the state indicates quota has been applied, then UDM checks with HSS first if the UE is registered in EPS. If it is registered, then nothing happens. If the UE is not registered in EPS, then UDM interacts with the central NF holding the PLMN quota to restore the quota. At EPS detachment, HSS checks with UDM. Given that the implied S-NSSAI to be used is not known at this point in time, UDM performs quota check on all S-NSSAIs subject to quota and IWK as well. For each S-NSSAI, UDM checks first its internal state. If the state indicates quota has been applied and the UE is not registered in 5GS, then UDM interacts with the central NF holding the PLMN quota to restore the quota. Otherwise UDM does nothing.

FIG. 10 is a schematic block diagram of a network node 1000 according to some embodiments of the present disclosure. Optional features are represented by dashed boxes. The network node 1000 may be, for example, a network node that implements all or some of the functionality of a NF in the 5GC, a NF in the EPC, or a combined NF (e.g., SMF/PGW-C 214 or UDM/HSS 212) in accordance with any of the embodiments described herein. As illustrated, the network node 1000 includes one or more processors 1004 (e.g., Central Processing Units (CPUs), Application Specific Integrated Circuits (ASICs), Field Programmable Gate Arrays (FPGAS), and/or the like), memory 1006, and a network interface 1008. The one or more processors 1004 are also referred to herein as processing circuitry. The one or more processors 1004 operate to provide one or more functions of the network node 1000 as described herein. In some embodiments, the function(s) are implemented in software that is stored, e.g., in the memory 1006 and executed by the one or more processors 1004.

FIG. 11 is a schematic block diagram that illustrates a virtualized embodiment of the network node 1000 according to some embodiments of the present disclosure. This discussion is equally applicable to other types of network nodes. Further, other types of network nodes may have similar virtualized architectures. Again, optional features are represented by dashed boxes.

As used herein, a “virtualized” network node is an implementation of the network node 1000 in which at least a portion of the functionality of the network node 1000 is implemented as a virtual component(s) (e.g., via a virtual machine(s) executing on a physical processing node(s) in a network(s)). As illustrated, in this example, the network node 1000 includes one or more processing nodes 1100 coupled to or included as part of a network(s) 1102. If present, the control system 1002 or the radio unit(s) are connected to the processing node(s) 1100 via the network 1102. Each processing node 1100 includes one or more processors 1104 (e.g., CPUs, ASICs, FPGAs, and/or the like), memory 1106, and a network interface 1108.

In this example, functions 1110 of the network node 1000 described herein are implemented at the one or more processing nodes 1100 or distributed across the two or more processing nodes 1100 in any desired manner. In some particular embodiments, some or all of the functions 1110 of the network node 1000 described herein are implemented as virtual components executed by one or more virtual machines implemented in a virtual environment(s) hosted by the processing node(s) 1100.

In some embodiments, a computer program including instructions which, when executed by at least one processor, causes the at least one processor to carry out the functionality of the network node 1000 or a node (e.g., a processing node 1100) implementing one or more of the functions 1110 of the network node 1000 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 12 is a schematic block diagram of the network node 1000 according to some other embodiments of the present disclosure. The network node 1000 includes one or more modules 1200, each of which is implemented in software. The module(s) 1200 provide the functionality of the network node 1000 described herein. This discussion is equally applicable to the processing node 1100 of FIG. 11 where the modules 1200 may be implemented at one of the processing nodes 1100 or distributed across multiple processing nodes 1100.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

1. A method for handling one or more quotas for a network slice that supports interworking between a Fifth Generation system, 5GS, and an Evolved Packet system, EPS, the method comprising:
at a first Network Function, NF:
receiving a message associated to:
registration of a User Equipment, UE, with the 5GS for a particular network slice that supports interworking between the 5GS and the EPS;
attachment of the UE with the EPS for the particular network slice;
establishment of a Protocol Data Unit, PDU, session in the 5GS for the particular network slice; or
establishment of a Packet Data Network, PDN, connection in the EPS for the particular network slice;
determining that a quota check for a quota is needed for the UE for the particular network slice; and
performing a procedure to check the quota for the particular network slice and, if needed, update an associated count, upon determining that a quota check is needed.

2. The method of claim 1 wherein the quota is a quota for a number of registered UEs for the particular network slice.

3. The method of claim 2 wherein the first NF is a Unified Data Management, UDM, or a combined UDM/Home Subscriber Server, HSS.

4. The method of claim 2 wherein determining that a quota check for the quota is needed for the UE for the particular network slice comprises determining that the network slice supports interworking and is subject to the quota.

5. The method of claim 2 wherein determining that a quota check for the quota is needed for the UE for the particular network slice comprises determining that the UE has not already been counted in a number of UEs registered for the particular network slice.

6. The method of claim 2 wherein, prior to receiving the message, the UE was handed over from the 5GS to the EPS or vice versa, and determining that a quota check for the quota is needed for the UE for the particular network slice comprises determining that the UE has not already been counted in a number of UEs registered for the particular network slice prior to being handed over.

7. The method of claim 2 wherein the associated count is not increased if the UE has already been counted in a number of UEs registered for the particular network slice.

8. The method of claim 1 wherein the quota is a quota for a number of sessions for the particular network slice.

9. The method of claim 8 wherein the first NF is a Session Management Function, SMF, or a combined SMF and Packet Data Network, PDN, Gateway Control plane, PGW-C.

10. The method of claim 8 wherein determining that a quota check for the quota is needed for the UE for the particular network slice comprises determining that the network slice supports interworking and is subject to the quota.

11. The method of claim 8 wherein determining that a quota check for the quota is needed for the UE for the particular network slice comprises determining that a session of the UE over the particular network slice has not already been counted in a number of sessions for the particular network slice.

12. The method of claim 8 wherein, prior to receiving the message, the UE was handed over from the 5GS to the EPS or vice versa, and determining that a quota check for the quota is needed for the UE for the particular network slice comprises determining that a session of the UE over the particular network slice has not already been counted in a number of sessions for the particular network slice prior to being handed over.

13. The method of claim 8 wherein the associated count is not increased if the session of the UE has already been counted for the particular network slice.

14. The method of claim 1 wherein performing the procedure to check the quota for the particular network slice and, if needed, update an associated count comprises:
sending a message to a central NF to request a quota check for the quota for the particular network slice;
receiving a response from the central NF; and
determining whether the quota has been reached based on the response from the central NF.

15. The method of claim 14 wherein performing the procedure to check the quota for the particular network slice and, if needed, update an associated count further comprises sending a notification to the central NF to adjust a count maintained for the quota upon determining that the quota has not been reached, and otherwise refraining from sending a notification to the central NF to adjust the count maintained for the quota.

16. The method of claim 14 further comprising, at the central NF:
receiving a message from the first NF to request the quota check for the quota for the particular network slice; and
sending the response to the first NF.

17. The method of claim 15 further comprising, at the central NF, adjusting the count in response to receiving the notification from the first NF.

18. The method of claim 1 wherein performing the procedure to check the quota for the particular network slice and, if needed, update an associated count comprises adjusting the count locally upon determining that the quota has not been reached.

19. The method of claim 1 wherein performing the procedure to check the quota for the particular network slice and, if needed, update an associated count comprises checking the quota locally at the first NF.

20. (canceled)

21. (canceled)

22. A network node for handling one or more quotas for a network slice that supports interworking between a Fifth Generation system, 5GS, and an Evolved Packet system, EPS, the network node comprising processing circuitry configured to cause the network node to:
receive a message associated to:
registration of a User Equipment, UE, with the 5GS for a particular network slice that supports interworking between the 5GS and the EPS;
attachment of the UE with the EPS for the particular network slice;
establishment of a Protocol Data Unit, PDU, session in the 5GS for the particular network slice; or
establishment of a Packet Data Network, PDN, connection in the EPS for the particular network slice;
determine that a quota check for a quota is needed for the UE for the particular network slice; and
perform a procedure to check the quota for the particular network slice and, if needed, update an associated count, upon determining that a quota check is needed.

23. (canceled)

24. A method performed by a central Network Function, NF, for handling one or more quotas for a network slice that supports interworking between a Fifth Generation system, 5GS, and an Evolved Packet system, EPS, the method comprising:
receiving a message from a first NF to request a quota check for a quota for a particular network slice; and
sending a response to the first NF.

25. The method of claim 24 further comprising:
receiving a notification from the first NF to adjust a count maintained for the quota; and
adjusting the count in response to receiving the notification from the first NF.

26. The method of claim 24 wherein the central NF increases the count if a respective UE or a respective session of the UE has not already been counted for the particular network slice.

27-29. (canceled)

30. A network node adapted for implementing a central Network Function, NF, for handling one or more quotas for a network slice that supports interworking between a Fifth Generation system, 5GS, and an Evolved Packet system, EPS, the network node processing circuitry configured to cause the network node to:
receive a message from a first NF to request a quota check for a quota for a particular network slice; and
send a response to the first NF.

31. (canceled)

32. (canceled)

33. A method for handling one or more quotas for a network slice that supports interworking between a Fifth Generation system, 5GS, and an Evolved Packet system, EPS, the method comprising:
at a first Network Function, NF:
maintaining a count of registered User Equipments, UEs, associated to a network slice that supports interworking between a Fifth Generation system, 5GS, and an Evolved Packet system, EPS, such that a UE is counted as a registered UE for the network slice if the UE has at least one session associated to the network slice in either the 5GS or the EPS.

34. The method of claim 33 wherein the first NF is a Unified Data Management, UDM, or a combined UDM/Home Subscriber Server, HSS.

35. (canceled)

36. The method of claim 34 wherein a UE is counted as a registered UE for the network slice if the UE has any of: (a) at least one Protocol Data Unit, PDU, session associated to the network slice in the 5GS or (b) at least one Packet Data Network, PDN, connection associated to the network slice in the EPS.
